(19) United States
(12) Patent Application Publication
(10) Pub. No.: US 2011/0232184 A1
(43) Pub. Date: Sep. 29, 2011

(54) STACKABLE PLANTER SUPPORT APPARATUS

(76) Inventor: Russell Thomas Fagan, Chester, NJ (US)

(21) Appl. No.: 12/748,238

(22) Filed: Mar. 26, 2010

(51) Int. Cl. F16M 11/24; F16M 11/02; F16M 11/26; F16M 11/22; F16M 11/38; A01G 9/02

(52) U.S. Cl. 47/66.6; 248/146; 248/132; 47/39; 47/66.7

(57) ABSTRACT

Embodiments of the present invention generally relate to a stackable planter support apparatus and methods of utilizing the same. More specifically, embodiments of the present invention relate to a planter support apparatus adapted for stacking upon the rim of an additional planter. In one embodiment of the present invention, a stackable planter support comprises a horizontal platform for supporting the weight of a first planter, and a plurality of leg supports extending from a bottom surface of the platform, a distal end of each of the leg supports having a notch for receiving the rim of a second planter.

### BACKGROUND OF THE INVENTION

1. Field of the Invention

Embodiments of the present invention generally relate to stackable planter support apparatus and a method of using same. More specifically, embodiments of the present invention relate to a planter support apparatus adapted for stacking on the rim of a second planter.

2. Description of Related Art

The art of planting, maintaining, and displaying potted plants is a form of horticultural activity enjoyed by many people throughout the world. Whether for improving aesthetic appearance of a room, harvesting plants for food, or using plants as a means to improve the quality of air in a given area, a large percentage of the world population own potted plants and house them in and around their homes, businesses and other viewing areas.

For many reasons, including those listed above, a large number of people desire to display a multitude of plants and plant varieties. A problem exists, however, when physical space for displaying plants is limited. Because space is limited in some places where plants are to be displayed, it is often desired to display planters in configurations that take up the smallest amount of floor surface area. For those who own more than one plant, the task of watering each plant can be time consuming.

In addition, with a growing interest in environmental protection and the “green” movement, many plant owners throughout the world desire mechanisms and methods for watering plants designed to conserve water. Water conservation efforts are attractive to many plant owners due to mounting global concerns over (1) availability of water for future generations; (2) general energy conservation, in that water pumping, delivery, and wastewater treatment facilities consume a significant amount of energy; (3) preserving fresh water habitats for local wildlife and migrating waterfowl; and (4) reducing the need to build new dams and other water diversion infrastructure. For at least these reasons, mechanisms and methods for watering plants designed to conserve water has gained increasing attention and interest among the plant owners of the world.

Attempted solutions to this problem include the use of stands or supports for displaying plants in planters. Current planter support designs include table-like displays adapted for the display of single planters, hook units for hanging planters from elevated locations, and bookshelf-type units for displaying multiple planters. Current designs for displaying multiple plants are large, bulky, and take up a significant amount of footprint or floor space and area. For example, many of such current designs are set to fixed positions and are capable of supporting a fixed number of plants, oftentimes of a set size. Such types of designs may be suitable for persons who frequently have the same number and same size of potted plants displayed. However, for many people, such lack of flexibility requires them to look elsewhere for a planter support apparatus capable of meeting their needs. Planters have proven difficult to stack for purposes of display and watering, especially those with round rims. Current designs fail to effectively and efficiently stack planters, including those with round rims. Current designs also generally do not allow for the most efficient use of water. When each potted plant displayed using these designs requires a separate source of water, water is not used in the most efficient manner.

Thus, there is a need for an improved water conserving, space efficient, stackable planter support apparatus and watering system and a method of using the same.

### SUMMARY

Embodiments of the present invention generally relate to a stackable planter support apparatus and a method of using the same. More specifically, embodiments of the present invention relate to a planter support apparatus adapted for stacking upon the rim of a second planter. In one embodiment of the present invention, a stackable planter support comprises a horizontal platform for supporting the weight of at least a first planter and a plurality of leg supports extending from a bottom surface of the platform, a distal end of each of the leg supports having a notch for receiving the rim of a second planter.

In another embodiment of the present invention, a stackable planter support kit is provided comprising: a planter having a rim surrounding an opening in a top side, a stackable planter support comprising a horizontal platform for supporting the weight of a first planter and a plurality of leg supports extending from a bottom surface of the platform, a distal end of each of the leg supports having a notch for receiving the rim of a second planter.

In another embodiment of the present invention, a method of stacking planters is provided comprising: providing a stackable planter support kit comprising: a first planter having a rim surrounding an opening in a top side, a stackable planter support comprising: a horizontal platform for supporting the weight of a first planter, a plurality of leg supports extending from a bottom surface of the platform, a distal end of each of the leg supports having a notch for receiving the rim of a second planter and a second planter having a rim surrounding an opening in an upper surface; placing each notch over the rim of the second planter; and placing the first planter on a surface of the horizontal platform.

In another embodiment of the present invention, a stackable planter support is provided comprising: a horizontal platform for supporting the weight of a first planter, the platform having a round shape and a concave top surface with a retaining lip surrounding the perimeter of the platform; three leg supports each having proximate ends and distal ends, the proximate ends attached to, and extending downwardly from, a bottom surface of the platform, and the distal ends of each of the leg supports having a notch for receiving the rim of a second planter; at least one aperture for allowing liquid to pass through the platform; and at least one channel for directing the liquid to the at least one aperture.

### BRIEF DESCRIPTION OF THE DRAWINGS

So the manner in which above recited features of the present invention can be understood in detail, a more particular description of embodiments of the present invention, briefly summarized above, may be had by reference to embodiments, several of which are illustrated in appended drawings. It is to be noted, however, appended drawings illustrate only typical embodiments of embodiments encompassed within the scope of the present invention, and, therefore, are not to be considered limiting, for the present invention may admit to other equally effective embodiments, wherein:

FIG. 1 depicts a perspective view of a stackable planter support in accordance with one embodiment of the present invention;

FIG. 1a depicts a front view of the stackable planter support of FIG. 1;

FIG. 1b depicts a top view of the stackable planter support of FIG. 1;

FIG. 2 depicts an exploded view of an exemplary embodiment of a stackable planter support kit in accordance with one embodiment of the present invention;

FIG. 3 depicts a perspective view of an exemplary embodiment of a stackable planter support in accordance with one embodiment of the present invention; and

FIG. 4 depicts a flow chart of an exemplary method in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

Embodiments of the present invention generally relate to a stackable planter support apparatus and a method of using the same. More specifically, embodiments of the present invention relate to a planter support apparatus adapted for stacking upon the rim of a second planter. Multiple planter support apparatus and multiple planters are considered within the scope of embodiments of the present invention.

As used herein, the term “notch” is understood to mean any cutout, recess, indentation, groove, or the like, formed in a portion of the stackable planter support apparatus. As used herein, the term “planter” is understood to mean any container capable of accepting a plant. All shapes and sizes of planters are considered within the scope of embodiments of the present invention. Planters without holes and planters with any number of holes of any size and shape in any location or pattern the planter capable of allowing liquid to pass through the planter are considered within the scope of embodiments of the present invention. For example, planters with one or more holes in a bottom surface of the planter for allowing liquid to pass through the bottom surface of the planter are considered within the scope of embodiments of the present invention.

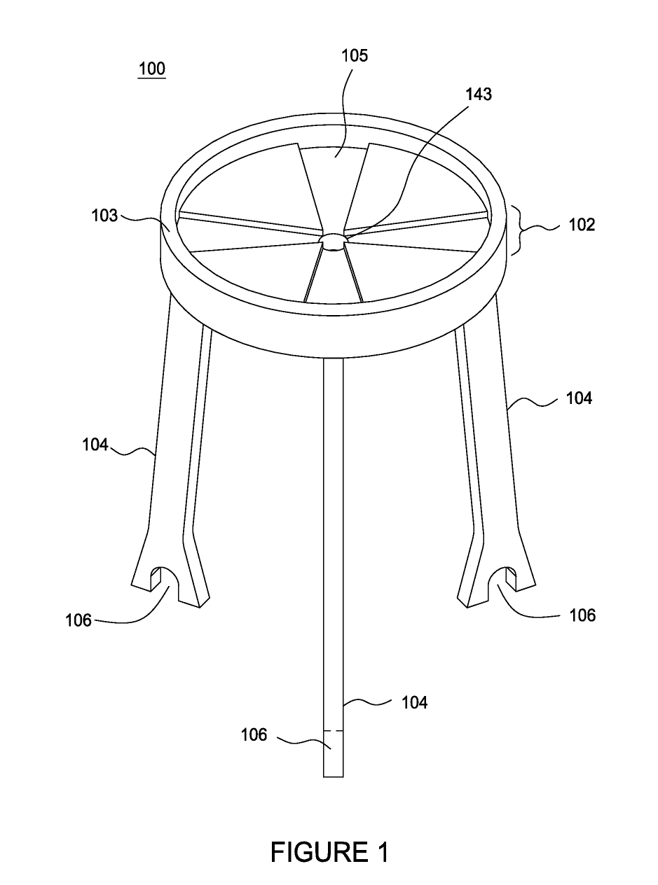

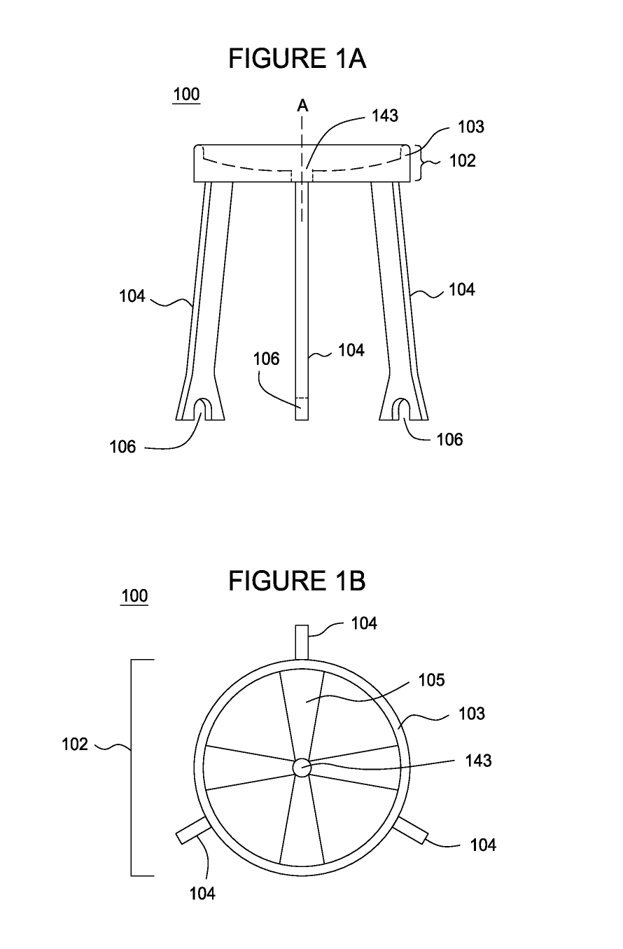

FIG. 1 depicts a perspective view of a stackable planter support 100 in accordance with one embodiment of the present invention. A stackable planter support 100 generally comprises a horizontal platform 102 and a plurality of leg supports 104 extending from a bottom surface of the platform 102. In accordance with many embodiments of the present invention, each of the plurality of leg supports 104 may be attached or fastened to the bottom surface of the platform 102, using any means suitable for embodiments of the present invention. In one exemplary embodiment of the present invention, each of the plurality of leg supports 104 may be attached to the bottom surface of the platform 102 using a pressure-fitted fastening means, or a screw, nail, staple, or any type of fastening means drilled through a top surface of the horizontal platform 102 into each of the plurality of leg supports 104. In alternative embodiments of the present invention, each of the plurality of leg supports 104 may be surface-mounted, attached to the bottom surface of the horizontal platform 102 using a screw, nail, staple, bolt, or bracket capable of securing each of the plurality of leg supports 104 to the bottom surface of the horizontal platform 102. In alternative embodiments of the present invention, each of the plurality of leg supports 104 may be attached to the bottom surface of the platform 102 by adhesive, glue, cement, mucilage, paste, plaster, stickum, and the like. A distal end of each of the plurality of legs supports 104 generally may include a notch 106 for receiving a rim of a planter (not shown). Although three leg supports 104 are shown, any number of leg supports may be provided to support the horizontal platform 102. In one embodiment of the present invention, the platform may comprise a single solid surface. In alternative embodiments of the present invention, the platform may comprise at least one drainage aperture 143. In alternative embodiments of the present invention, the platform may comprise multiple drainage apertures 143. In alternative embodiments of the present invention, the platform 102 may comprise a raised retaining lip 103 for containing liquid within the perimeter of a top surface of the platform 102. In alternative embodiments of the present disclosure, the platform 102 may comprise at least one drainage channel 105 to facilitate the directing of water to any point on the top surface of the horizontal platform 102.

The size of the stackable planter support 100 may generally be dependent upon the size of the planter on which it will be stacked, upon the size of the planter that it will be supporting, or may be manufactured to any size, scale, or shape suitable for embodiments of the present invention. In accordance with exemplary embodiments of the present invention, the stackable planter support 100 may be of a size capable of fitting industry-standard 8″, 10″, 14″, and 16″ planters, but is in no way limited to such sizes.

The stackable planter apparatus 100 may comprise, for example, any suitable material such as wood, plastic, Trex®, metal, synthetic materials, glass, natural stone, marble, concrete, granite, bamboo, straw, rush, vine, hemp, fabric, natural or synthetic fibers, and the like. In many embodiments, the stackable planter apparatus 100 may comprise a hollow or solid construction, depending upon the nature of the materials used and/or the features of the particular embodiment constructed, as described herein. The materials used may aid in the control and distribution of water.

The horizontal platform 102 may generally be of any size, scale, or shape suitable for embodiments of the present invention. In one embodiment of the present invention, the horizontal platform may be constructed of a solid material, for example, metal, synthetic materials, glass, natural stone, marble, concrete, granite, bamboo, and the like. In alternative embodiments of the present invention, the horizontal platform may be constructed of a liquid permeable material, meshed material, woven material, or weaved material, capable of supporting a potted plant of any size, for example, wire mesh, metal mesh, straw, twine, rush, vine, hemp, fabric, natural or synthetic fibers, and the like. In one embodiment of the present invention, the perimeter of the horizontal platform 102 may be flat. In alternative embodiments of the present invention, the perimeter of the horizontal platform 102 may have the raised retaining lip 103, which may be located on the side or the top surface of the horizontal platform 102. In one exemplary embodiment, the horizontal platform 102 comprises a round shape of between about six to about eighteen inches in diameter. In another embodiment, the horizontal platform 102 may comprise about a ten inch diameter. In addition to diametric shape, in some embodiments, the horizontal platform 102 may comprise any level or measurement of concavity. While embodiments of the present invention require the horizontal platform 102 to support a vertical weight of a planter resting thereon, in certain embodiments, a slight downward concavity is provided to the horizontal platform 102. Such embodiments are described in more detail infra. In alternative embodiments of the present invention, the top surface of the horizontal platform 102 may be flat.

The horizontal platform 102 may comprise at least one drainage channel 105 to facilitate the directing of water to any point on the top surface of the horizontal platform 102. In one exemplary embodiment, the horizontal platform 102 may comprise drainage channels 105 directing water to the center of the top surface of the horizontal platform. In another exemplary embodiment, the horizontal platform 102 may comprise drainage channels 105 directing water to at least one drainage aperture 143. In alternative embodiments of the present disclosure, the at least one drainage channel 105 may comprise a groove, notch, slot, or similar channel of any width, depth, length and pattern capable of directing water to any point on the top surface of the horizontal platform 102. In alternative embodiments of the present disclosure, the at least one drainage channel 105 may comprise a groove, notch, slot, or similar channel of any width, depth, length and pattern capable of directing water to any point off the of the horizontal platform 102. In one embodiment of the present invention, the at least one drainage channel 105 may comprise a straight line. In alternative embodiments the at least one drainage channel 105 may comprise any pattern or curvature capable of directing water to any point on the top surface of the horizontal platform 102.

In accordance with many embodiments of the present invention, the stackable planter support 100 may be adapted to allow water or liquid to pass through the platform 102 for watering plants contained in planters located below the stackable planter support. The stackable planter support 100 may generally comprise at least one drainage aperture 143 for allowing liquid to pass through the horizontal platform 102. In many embodiments, the at least one drainage aperture 143 may be in any location or pattern on the horizontal platform 102. Although one circular drainage aperture 143 through the center of the horizontal platform 102 is depicted on in FIG. 1, the use of any number of drainage apertures 143 in any shape and size, located in any position or pattern is contemplated in the embodiments of the present invention. Although a solid horizontal platform 102 is depicted in FIG. 1, alternatively, the horizontal platform 102 may be constructed of porous or pervious material capable of supporting a planter while allowing liquid to drain through the platform 102. In accordance with alternative embodiments of the present invention, the platform 102 may comprise a retaining lip 103. The retaining lip 103 may be of any size and shape and made of any material capable of containing a liquid, e.g., water, within the perimeter or a section of the top surface of the platform 102.

In an alternative embodiment of the present invention, the top surface of the horizontal platform 102 may comprise at least one drainage channel 105. The drainage channel may generally comprise any groove, channel, contour, or other channeling means (not shown) for channeling a liquid, such as water, to a point on the top surface of the platform 102, for example, to the at least one drainage aperture 143. The grooves, channels, contours, or other means for channeling a liquid may be in any location or in any pattern on the top surface of the horizontal platform 102.

Each of the plurality of leg supports 104 may generally comprise any length suitable for embodiments of the present invention. In many embodiments of the present invention, each of the plurality of leg supports may comprise a length of between about eight inches to about twenty-four inches. In one embodiment, each of the plurality of leg supports comprises a length of about sixteen inches long. Generally, however, the height of the leg supports 104 may be dependent upon the nature of the height of plants in the planters over which the stackable planter supports will be provided.

In accordance with another embodiment of the present invention, each of the plurality of leg supports 104 may be height-adjustable, for example, by use of a low-friction telescoping mechanism, a telescopic cylinder or the like. In accordance with another embodiment of the present invention, each of the plurality of leg supports 104 may be vertical supports that can be extended or shortened to move the horizontal platform 102 to different elevated heights and adjust it above and around a planter below (not pictured). In another embodiment, each of the plurality of leg supports 104 may be collapsible to allow for storage of the stackable planter support 100. In one such embodiment, foldable leg supports may be pivotable about a hinge (not shown) at the intersection of each leg support 104 and the horizontal platform 102, allowing the leg supports 104 to rest flat against the bottom surface of the horizontal platform 102, when not in use. Alternatively, telescoping mechanisms, similar to those of a camera tripod, may be used to both extend the height and collapse the height of the leg supports 104 in accordance with embodiments of the present invention.

Each of the notches 106 may generally be of adequate size to securely and safely surround the rim of any sized planter and resist forces in order to prevent the stackable planter support 100 from slipping off the rim of the planter. In many embodiments, the notches 106 may comprise, but not be limited to, a downwardly facing, substantially U-shaped opening. In an alternative embodiment, each of the notches 106 may be adjustable, for example, by using an adjustable clamp (not shown) or other means for adjusting the thickness of the notches for purposes of creating a more secure friction fit between the planter support apparatus and the planter.

Generally, in operation, water or any other liquid poured over the top of or into the stackable planter support 100 passes through the at least one drainage aperture 143 to a point below the horizontal platform 102. Depending on the configuration of the at least one drainage aperture 143, the liquid may exit onto an article that may be positioned underneath the horizontal platform 102 (e.g., a planter).

FIG. 1a depicts a perspective view of an exemplary embodiment of the stackable planter support 100 of FIG. 1. The stackable planter support 100 may generally comprise a horizontal platform 102, a plurality of leg supports 104 having a notch 106 at a distal end, a retaining lip 103, at least one drainage aperture 143, and at least one drainage channel 105 as depicted in FIG. 1. In certain embodiments of the present invention, the top surface of the horizontal platform 102 may comprise a concavity, as shown in FIG. 1a. The concavity of the top surface may comprise any level of concavity measured to a center axis A passing vertically through a center of the horizontal platform 102. In one embodiment, the concavity of the top surface is sufficient to allow a liquid, such as water, to freely flow to a point on the center axis on the top surface by virtue of gravity. Alternatively, the concavity of the top surface may be such that horizontal platform has a visually definable volume within the concavity.

It should be appreciated, each of the features discussed with respect to the embodiment shown in FIG. 1a may exist independently of each other, in accordance with further embodiments of the present invention.

FIG. 1b depicts a top view of the stackable planter support 100 of FIG. 1. The exemplary embodiment of a stackable planter support 100 may generally comprise a horizontal platform 102, a plurality of leg supports 104, a retaining lip 103, and at least one drainage aperture 143 like those described in FIG. 1. Although each of the plurality of leg supports 104 are depicted as spaced apart in substantially equivalent increments in FIG. 1b, any spacing capable of supporting of any size potted plant is contemplated within the embodiments of the present invention.

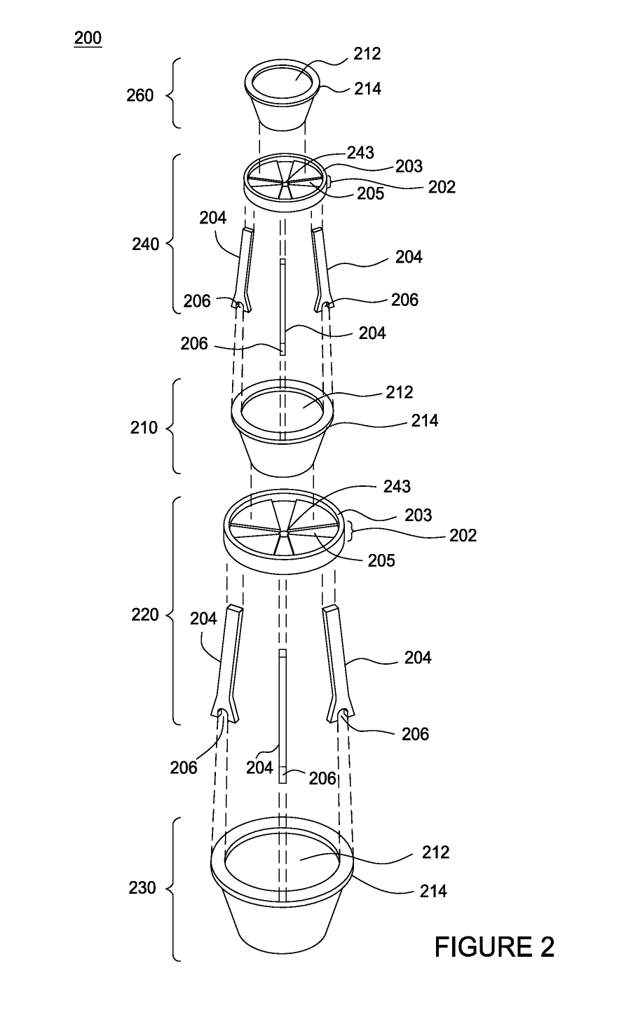

FIG. 2 depicts an exploded view of a stackable planter support kit 200 in accordance with one embodiment of the present invention. The stackable planter support kit 200 may generally comprise a first planter 210, a first stackable planter support 220, a second planter 230 and optionally, a second stackable planter support 240 and a third planter 260. Each of the first, second, and third planters 210, 230, 260 comprise a rim 214 and an opening in a top side 212, allowing access to the respective volume therein.

The first and second stackable planter supports 220, 240, may generally be substantially similar to the planter support apparatus depicted in FIG. 1. The stackable planter supports 220, 240 may generally comprise a horizontal platform 202, a plurality of leg supports 204 having a notch 206 at a distal end, a retaining lip 203, at least one drainage aperture 243, and at least one drainage channel 205 similar to that depicted in FIG. 1. The first, second, and third planters 210, 230, 260 may generally be dependent upon the size of the plant to be supported, and may be manufactured to any size, scale, or shape suitable for embodiments of the present invention. In many embodiments, the first, second, and third planters 210, 230, 260 are industry-standard planters, as known by those in the industry.

As shown in FIG. 2, the first planter 210 may be positioned on a top surface of a horizontal platform 202 of the first stackable planter support 220. The notches 206 of the first stackable planter support 220 are positioned at the distal end of each of the plurality of leg supports 204, and are aligned with the rim 214 of the second planter 230, over the opening the top side 212. In many embodiments, the second planter 230 may be resting on a table (not shown), the ground, or other stable surface. Alternatively, the second planter 230 may be resting on the horizontal platform of an additional stackable planter support (not shown). In accordance with embodiments of the present invention, the second stackable planter support 240 may be resting on the first planter 210. In accordance with embodiments of the present invention, the notches 206 of the second stackable planter support 240 are positioned at the distal end of each of the plurality of leg supports 204, and aligned with the rim 214 of the first planter 210, over the opening in the top side 212. In many embodiments, the third planter 260 may be resting on a top surface of the horizontal platform 202 of the second stackable planter support 240. Embodiments of the present invention appreciate no limit exists to the number of stacked planters and stackable planter supports, as described herein.

In an alternative embodiment of the present invention, the stackable planter supports 220, 240 may comprise adjustment holes (not shown) in the horizontal platform 202 at predetermined intervals and predetermined angles to allow fastening of each of the plurality of leg supports 204 to the bottom surface of the horizontal platform 202 at the points of the adjustment holes at the predetermined intervals and predetermined angles. In accordance with embodiments of the present invention, the horizontal platform 202 may be marked with an indication (not shown), for example a “+” or “−” to indicate adjustability of each of the plurality of leg supports 204 for use for planter of larger or smaller diameter. In an alternative embodiment of the present disclosure, each of the plurality of leg supports 204 may be slidably fastenable to the bottom surface of the horizontal platform 202, for example, by way of a grove or a slider track (not shown) in which each of the plurality of leg supports 204 may be slid inward toward the center of the horizontal platform 202 and outward away from the center of the horizontal platform 202 and tightened with a fastening device. The fastening device may be, for example, a wing-nut and bolt or any means capable of locking or securing the plurality of leg supports 204 into position on the groove or slider track. For example, each of the plurality of leg supports 204 may be adjustable 2″ inward toward the center of the horizontal platform 202 or outward 2″ away from the center of the horizontal platform 202.

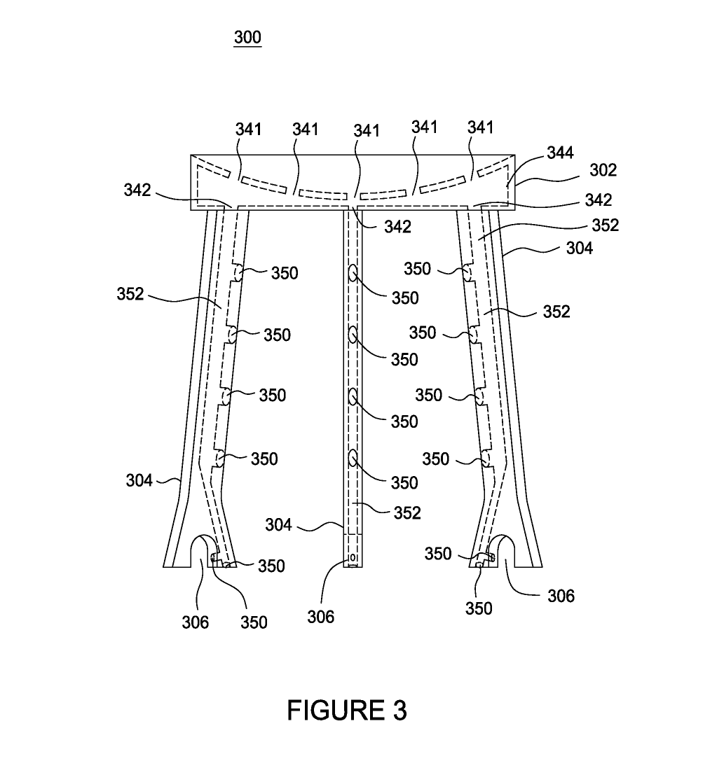

FIG. 3 depicts a perspective view of a stackable planter support 300 in accordance with one embodiment of the present invention. In accordance with many embodiments of the present invention, the stackable planter support 300 is adapted to allow water or liquid to pass through the horizontal platform 302 for watering plants contained in planters located below the stackable planter support. The stackable planter support 300 may generally comprise a substantially hollow drainage basin 344 within the horizontal platform 302 for allowing liquid to pass through a top surface of the platform through at least one top surface drainage hole 341.

As shown in FIG. 3, at least one bottom surface drainage hole 342 may be positioned through the bottom surface of the horizontal platform 302 for allowing liquid to pass through from the basin 344. In many embodiments, the drainage hole(s) 341, 342 may be in any pattern across the top and bottom surfaces of the horizontal platform 302. Although defined holes 341, 342 are depicted in FIG. 3, alternatively, the horizontal platform 302 may be constructed of porous material capable of supporting a planter while allowing liquid to drain from the platform 302 to the next planter, situated below the first planter.

In other embodiments, the bottom surface drainage hole(s) 342 may also or alternatively be positioned over a plurality of leg supports 304 extending from the bottom surface of the horizontal platform 302, wherein a distal end of each of the leg supports 304 has a notch 306 for receiving the lip of a planter. In such an embodiment, the leg supports 304 may each comprise one or more leg drainage outlets 350. The leg drainage outlets 350 may be positioned in any location on the leg supports 304, for example, on the top, on the middle, on the bottom, adjacent the notch or any combination of locations on the leg supports 304. Although five leg drainage outlets 350 are depicted on each leg support 304 in FIG. 3, using any number of leg drainage outlets in any pattern is contemplated within the embodiments of the present invention. In addition to the leg drainage outlets 350, in certain embodiments, the leg supports 304 may also comprise a substantially hollow drainage channel 352 for allowing liquid to travel from the bottom surface drainage hole(s) 342 to the leg drainage outlets 350. In accordance with many embodiments of the present invention the substantially hollow drainage channel 352 may extend either partially, a majority, or all the way through the leg supports 304.

Generally, in operation, water or any other liquid poured over the top of the stackable planter support 300 passes through the top surface drainage holes 341 in the top of the platform 302 into the substantially hollow drainage basin 344. Such liquid may be poured directly from a liquid source (not shown) onto the top surface of the horizontal platform, or more likely, may be residual liquid from a planter sitting on the top surface of the horizontal platform. Once in the hollow drainage basin 344, the liquid may then generally pass through the bottom surface drainage holes 342 in the bottom surface of the horizontal platform 302.

Depending on the configuration of the bottom surface drainage holes 342, the liquid may exit the hollow drainage basin onto an article that may be positioned underneath the horizontal platform 302 (e.g., a planter) or may exit into the substantially hollow drainage channel 352 for allowing liquid to pass through at least one of the plurality of leg supports 304. The substantially hollow drainage channel 352 may be of any size or shape capable of allowing water to pass through at least one of the plurality of leg supports 304. The liquid may then exit through leg drainage outlets 350 onto an article that may be positioned adjacent thereto (e.g., a planter). By allowing excess water to flow from one planter to at least one additional planter, the water is used in an efficient manner, thus contributing to water conservation.

In certain embodiments of the present invention, the top surface of the horizontal platform 302 may comprise a slight concavity, as shown in FIG. 3. The concavity of the top surface may comprise any level of concavity measured to a center axis passing vertically through a center of the horizontal platform 302. In one embodiment, the concavity of the top surface is sufficient to allow a liquid, such as water, to freely congregate at a point on the center axis on the top surface by virtue of gravity. Alternatively, the concavity of the top surface may be such that horizontal platform has a visually definable volume within the concavity.

It should be appreciated herein, each of the features discussed with respect to the embodiment shown in FIG. 3 may exist independently of each other, in accordance with further embodiments of the present invention.

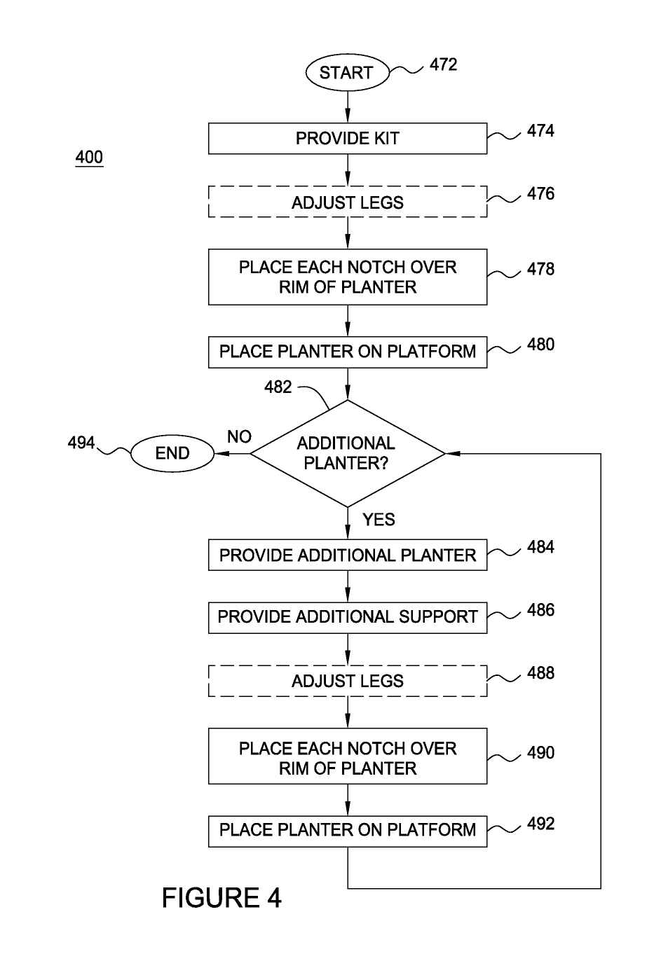

FIG. 4 depicts a flow chart of an exemplary method 400 in accordance with one embodiment of the present invention. Where applicable, reference is made to the stackable planter support kit 200, as described above with respect to FIG. 2. The method 400 begins at step 472.

In one embodiment of the present invention, at step 474, a stackable planter support kit is provided. The stackable planter support kit may comprise a first planter 210, a first stackable planter support 220, a second planter 230 and optionally, a second stackable planter support 240, a third planter 260, and any number of additional stackable planter supports and any number of additional planters. Each of the first, second, and third planters 210, 230, 260 comprise a rim 214 and an opening in a top side 212, allowing access to the respective volume therein.

At optional step 476, each leg support 204 of the first stackable planter support 220 may be adjusted to adapt to the rim 214 of planter 230. The leg supports 204 may be adjusted using any adjustable means suitable for embodiments of the present invention. In one embodiment, the adjustable means may comprise a spring-loaded clamp, a friction-fit clamping assembly, or the like. In an alternative embodiment of the present invention, the first stackable planter support 220 may be adjusted, for example, by using adjustment holes in the horizontal platform 202 at predetermined intervals and predetermined angles to allow fastening of each of the plurality of leg supports 204 to the bottom surface of the horizontal platform 202 at the points of the adjustment holes at the predetermined intervals and predetermined angles. In accordance with embodiments of the present invention, the horizontal platform 202 may be marked with an indication, for example a “+” or “−,” to indicate adjustability of each of the plurality of leg supports 204 for use for planter of larger or smaller diameter. In an alternative embodiment of the present disclosure, each of the plurality of leg supports 204 is slidably fastenable to the bottom surface of the horizontal platform 202, for example, by way of a grove or a slider track in which each of the plurality of leg supports 204 may be slid inward toward the center of the horizontal platform 202 and outward away from the center of the horizontal platform 202 and tightened with a fastening device. The fastening device may be, for example, a wing-nut and bolt or any means capable of locking or securing the plurality of leg supports 204 into position on the slider or groove. In accordance with an alternative embodiment, each of the plurality of leg supports 204 may be adjustable, for example 2″ inward toward the center of the horizontal platform 202 or outward 2″ away from the center of the horizontal platform 202.

At step 478, each notch 206 of the stackable planter support 220 is then placed over the rim 214 of the planter 230. When in place, the notch 206 should provide sufficient structural resistance such that the stackable planter support 220 is securely held in place over the planter 230 when used properly, in accordance with embodiments of the present invention. For example, when secured over the rim 214 of the planter 230, the stackable planter support 220 may resist all reasonable horizontal forces applied to a side of the horizontal platform 202—as may occur if a person accidentally bumped into the stackable planter support 220. In addition, the stackable planter support 220 may evenly distribute forces over the rim 214 of the planter 230, such that a reasonable amount of weight may be directly or indirectly supported by the horizontal platform 202 of the stackable planter support 220.

At step 480, a planter 210 is placed on the top surface of the horizontal platform 202 of the stackable planter support 220. In many embodiments, the planter 210 is substantially identical to the planter 230.

At step 482, a decision is made as to whether an additional planter is needed. If an additional planter is not needed, the method ends at step 494. If an additional planter is needed, a third planter is provided at step 484.

At step 484, a third planter 260 having a rim 214 surrounding an opening in an upper surface of the planter is provided, and at step 486, a second stackable planter support 240 is provided. At step 486, similar to step 476 above, the leg supports 204 on the second stackable planter support 240 may be adjusted to accommodate the rim 214 of planter 210, discussed supra.

At step 490, each notch of the second stackable planter support 240 may then be placed over the rim 214 of the planter 210. Accordingly, at step 492, the third planter 260 is placed on the surface of the horizontal platform 202 of the second stackable planter support 240. The method then returns to step 482. It should be appreciated, any number of planters and corresponding stackable planter supports may be provided, and the steps of the method 400 may be repeated as many times as necessary.

While the foregoing is directed to embodiments of the present invention, other and further embodiments of the invention may be devised without departing from the basic scope thereof. It is understood that various embodiments described herein may be utilized in combination with any other embodiment described, without departing from the scope contained herein.

What is claimed is:

1. A stackable planter support comprising:
a horizontal platform for supporting the weight of a first planter; and
a plurality of leg supports extending from a bottom surface of the platform, a distal end of each of the leg supports having a notch for receiving the rim of a second planter.

2. The stackable planter support of claim 1, wherein each of the plurality of leg supports is attached to the bottom surface of the platform.

3. The stackable planter support of claim 1, wherein each of the plurality of leg supports is a vertical support that can be extended or shortened to adjust the horizontal platform to different elevated heights above and around the second planter.

4. The stackable planter support of claim 3, wherein each vertical support can be extended or shortened with a telescoping mechanism.

5. The stackable planter support of claim 1, wherein a top surface of the platform is concave.

6. The stackable planter support of claim 1, wherein a top surface of the platform comprises a channel for directing water to a location on a top surface of the platform.

7. The stackable planter support of claim 1, wherein a top surface of the platform comprises a liquid permeable mesh material.

8. The stackable planter support of claim 1, further comprising:
at least one aperture for receiving liquid for passing through the horizontal platform.

9. The stackable planter support of claim 1, further comprising:
a slider track on the bottom surface of the platform for allowing each of the plurality of leg supports to slide inward toward the center of the platform or outward away from the center of the platform, wherein each of the plurality of leg supports is attached to the slider track; and
a fastening device for securing the plurality of leg supports in a locked position on the slider track.

10. The stackable planter support of claim 1, wherein each of the plurality of leg supports is collapsible for allowing storage of the stackable planter support.

11. The stackable planter support of claim 1, wherein each of the plurality of leg supports is a foldable leg support pivotable about a hinge at the intersection of each leg support and the horizontal platform.

12. The stackable planter support of claim 1, wherein the platform is round.

13. The stackable planter support of claim 1, wherein the stackable planter support comprises three leg supports.

14. The stackable planter support of claim 1, wherein the platform comprises substantially porous material for allowing liquid to drain below the platform.

15. The stackable planter support of claim 1, wherein the platform further comprises:
a substantially hollow drainage basin within the platform for accepting and channeling liquid passed through a top surface of the platform;
at least one top surface drainage hole in fluid communication with the drainage basin, the top surface drainage hole located in the top surface of the platform for allowing liquid to pass through the top surface of the platform and enter the basin; and
at least one bottom surface drainage hole in the bottom surface of the platform for allowing liquid from the basin to pass through the bottom surface of the platform.

16. The stackable planter support of claim 15, wherein each of the plurality of leg supports comprise:
a hollow drainage channel for allowing liquid to pass through each of the plurality of leg supports from at least one bottom surface drainage hole; and
at least one leg drainage outlet for allowing liquid from the channel to pass through the outlet to the second planter.

17. The stackable planter support of claim 16, wherein at least one leg drainage outlet is located on a side of the leg.

18. The stackable planter support of claim 1, wherein the notch comprises an adjustable clamp for adapting to different rim sizes.

19. A stackable planter support kit comprising:
a planter having a rim surrounding an opening in a top side;
a stackable planter support comprising:
a horizontal platform for supporting the weight of a first planter; and
a plurality of leg supports extending from a bottom surface of the platform, a distal end of each of the leg supports having a notch for receiving the rim of a second planter.

20. The stackable planter support kit of claim 19 further comprising:
a second planter having a rim surrounding an opening in a top side.

21. The stackable planter support kit of claim 19, wherein each of the plurality of leg supports is attached to the bottom surface of the horizontal platform.

22. The stackable planter support kit of claim 19, wherein each of the plurality of leg supports is collapsible for allowing storage of the stackable planter support.

23. The stackable planter support kit of claim 19, wherein each of the plurality of leg supports is a foldable leg support pivotable about a hinge at the intersection of each leg support and the horizontal platform.

24. A method of stacking planters comprising:
providing a stackable planter support kit comprising:
a first planter having a rim surrounding an opening in a top side;
a stackable planter support comprising:
a horizontal platform for supporting the weight of a first planter;
a plurality of leg supports extending from a bottom surface of the platform, a distal end of each of the leg supports having a
notch for receiving the rim of a second planter; and
a second planter having a rim surrounding an opening in an upper surface;
placing each notch over the rim of the second planter; and
placing the first planter on a surface of the horizontal platform.

25. The method of stacking planters of claim 24, further comprising:
providing a third planter having a rim surrounding an opening in an upper surface;
providing a second stackable planter support comprising:
a horizontal platform for supporting the weight of the third planter; and
a plurality of leg supports extending from a bottom surface of the platform, a distal end of each of the leg supports having a notch for receiving the rim of the first planter;
placing each notch of the second stackable planter support on the rim of the first planter; and
placing the third planter on a top surface of the horizontal platform of the second stackable planter support.

26. A stackable planter support comprising:
a horizontal platform for supporting the weight of a first planter, the platform having a round shape and a concave top surface with a retaining lip surrounding the perimeter of the platform;
three leg supports each having a proximate end and a distal end, the proximate end attached to, and extending downwardly from a bottom surface of the platform, the distal end of each of the leg supports having a notch for receiving the rim of a second planter;
at least one aperture for allowing liquid to pass through the platform; and
at least one channel for directing the liquid to the at least one aperture.
